(19) United States
(12) Patent Application Publication
(10) Pub. No.: US 2006/0162385 A1
(43) Pub. Date: Jul. 27, 2006

(54) Press mold and method of manufacturing optical element

(75) Inventors: Kenji Yamanaka, Tokyo (JP); Xuelu Zou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/334,568

(22) Filed: Jan. 19, 2006

(30) Foreign Application Priority Data
Jan. 19, 2005 (JP) 2005-11990

(51) Int. Cl. C03B 23/00; C03B 11/00

(52) U.S. Cl. 65/102; 65/305

(57) ABSTRACT

A peripheral portion of a molding material 50 on its lower side is supported on a support member 40 provided around a molding surface 21 of a lower mold 20 and an open space is ensured outward of an edge portion of the molding material 50 supported on the support member 40. In this state, the molding material 50 is press-molded between an upper mold 10 and the lower mold 20.

This application claims priority to prior Japanese patent application JP 2005-11990, the disclosure of which is incorporated herein by reference.

### BACKGROUND OF THE INVENTION

This invention relates to a press mold that is adapted to press-mold a molding material such as a glass by the use of upper and lower molds applied with precision machining and does not require post-processing such as grinding or polishing with respect to a molded surface, and further relates to an optical element manufacturing method using such a press mold. This invention particularly relates to a press mold that can satisfactorily supply a molding material onto a molding surface of a lower mold having a convex surface or a flat surface when molding an optical element such as a concavo-concave lens or a flat-concave lens, and further relates to an optical element manufacturing method using such a press mold.

A method is known where a molding material such as a glass is heated to be softened and then press-molded by a pair of upper and lower molds precisely machined into predetermined shapes, thereby manufacturing an optical element such as a lens [see, e.g. Patent Document 1 (Japanese Patent (JP-B) No. 3501580) and Patent Document 2 (Japanese Unexamined Patent Application Publication (JP-A) No. H09-286622)].

Patent Document 1 describes a molding method where a pair of positioning members are moved in a press mold comprising upper and lower molds and are brought into contact with an optical material (molding material) in a sandwich manner, thereby positioning the optical material with respect to the press mold. It is described that, particularly, when molding a concavo-concave lens, the optical material is placed on the lower mold having a convex shape and, therefore, if it is placed in an offset manner, there is a possibility of slipping off the lower mold and thus the positioning of the optical material is required in the press mold.

Patent Document 2 describes a method where a glass preform (molding material) is held at its end surface by holding means at a position spaced apart from a press mold comprising upper and lower molds, then heated, released from the holding means, and then pressed. It is described that, with this configuration, a chemical reaction between the glass preform and the press mold can be avoided during heating and molding can be carried out without impeding the flow of the glass preform in its radial direction during pressing.

When forming a molding material (glass material etc.) into an optical element such as a lens by precision press molding, it is general that the molding material is press-molded between a pair of upper and lower molds having opposed molding surfaces. In this event, it is necessary to supply and place the molding material on the molding surface of the lower mold in advance, but, depending on the shape of the optical element to be obtained, it is not necessarily easy to place the molding material at the center position of the molding surface of the lower mold.

As such an example, there can be cited a case of, for example, supplying and placing the molding material on the molding surface of the lower mold having a flat surface or a convex surface, such as a case of molding a flat-concave lens or a concavo-concave lens. Particularly, when the molding material has a convex curved surface, i.e. the surface of the molding material facing the lower mold is not a flat surface, positioning of the molding material is difficult even if the molding surface of the lower mold is flat.

In those cases, when, for example, the molding material placed on the molding surface of the lower mold is offset in position or slips off at the time of press molding, thickness deviation occurs in an optical element to be molded so that not only shape failure is resulted, but also surface accuracy in terms of the optical function is degraded due to unevenness in load application caused by the thickness deviation.

According to the description of Patent Document 1, the positioning members for the optical material are disposed in the press mold and these positioning members are moved in mutually opposite directions with respect to the reference position by the use of rack-and-pinion drive means and stopped when brought in contact with the optical material in the sandwich manner, so that positioning of the optical material is carried out with respect to the press mold. The positioning members are retreated by the drive means when or immediately before molding surfaces of the upper and lower molds contact the optical material at the time of pressing.

According to this method, however, since the positioning members are disposed inside the press mold, the structure of the press mold becomes quite complicated. Consequently, the heat capacity of the press mold increases so that it becomes difficult to efficiently execute a control of temperature rise and drop. Further, when the structure like the rack-and-pinion drive means is disposed near the press mold, not only a press molding machine increases in size, but also necessity arises to consider the influence of thermal deformation of the structure and so on, so that a machine design is extremely complicated.

When a press mold comprising upper and lower molds is fixed in a press molding machine to thereby carry out heating, pressing, and cooling at the same position, it is possible to some degree to perform positioning of a molding material by the use of the foregoing movable members that cause the complication of the machine. However, in a molding method where a molding material is placed in a press mold separated from a press molding machine and proper processes are applied to the press mold in sequence while transferring the press mold in the machine (details of the method will be described later), it is extremely inefficient to provide the foregoing elaborate movable members for each of individual press molds, which is practically impossible.

Patent Document 2 shows a drawing where a disk-shaped preform is press-molded by upper and lower molds each having a convex surface. Specifically, heating is carried out in the state where the preform is placed at an upper end of a holding ring, then the holding ring is moved downward by drive means so as to place the preform on the lower mold, and then the preform is pressed between the upper and lower molds. In this method, since the preform is in constant contact with the inner periphery of a lower sleeve, position offset of the preform does not appear to occur even when the molding surface of the lower mold has the convex shape.

However, in order to place the preform in such a manner, the outer diameters of individual preforms should be adjusted to be equal to each other so that the outer periphery of each preform is adapted to contact the inner periphery of the lower sleeve so as to be held thereby. Further, even when the outer diameter of each preform is not uniform, the preform cannot be properly held.

Accordingly, the roundness of a horizontal section of each preform needs to be precisely adjusted by pre-processing. In the pre-processing of the preform, machining such as polishing is normally required to set the size thereof within a predetermined range.

Although Patent Document 2 describes the example of using the molding material processed into the disk shape, it does not particularly refer to a forming method thereof. The molding material having such a shape can be generally obtained by cold-working, i.e. cutting and polishing, a glass block into the disk shape. However, such machining is disadvantageous in that it requires a number of steps and is thus complicated.

On the other hand, as a molding material for use in precision press molding, it is known to use a molding material obtained by dropping or pouring a molten glass onto a receiving mold so as to be preformed (hot-formed) into a spherical shape or a convex-convex curved shape, or a molding material obtained by further applying shape processing by hot-forming to the hot-formed molding material. The molding material thus obtained is normally covered with the convex curved surface with no surface defect and thus is quite advantageous in terms of forming an optical surface of a press-molded optical element, and further, is quite high in production efficiency. In addition, by controlling the flow rate of the dropping or pouring molten glass, it is possible to maintain volume accuracy and shape accuracy at more than certain levels.

However, it is not easy to supply and place the molding material having such a convex curved surface on the convex molding surface. Difficulties are encountered in making the molding material stationary on the molding surface at its center so that the molding material often slips off the molding surface or is often offset in position on the molding surface. Further, the external shape of the hot-formed molding material is generally not completely rounded so that a difference in diameter is caused in a certain range. If such a molding material is applied to Patent Document 2 as it is, the possibility is high that the molding material is taken into the inside of the lower sleeve, thereby impeding the press molding.

### SUMMARY OF THE INVENTION

This invention has been made under these circumstances and has an object to provide a press mold that can prevent slip-off of a molding material supplied on a molding surface of a lower mold without providing the elaborate movable members and, further, that can stably supply the molding material even if the molding material has a convex curved surface, and further provide an optical element manufacturing method using such a press mold.

In order to establish the above object, a press mold according to this invention comprises a lower mold formed with a molding surface having a convex or flat surface and an upper mold formed with a molding surface facing the molding surface of the lower mold. The press mold is adapted to press-mold between the upper and lower molds a molding material supplied to the lower mold. Accrodigng to an aspect of this invention, a support member is provided around the molding surface of the lower mold for supporting a peripheral portion of the molding material on its lower side and the support member supports the molding material so as to provide an open space outward of an edge portion of the molding material.

With this configuration, even if the molding surface of the lower mold has the convex or flat surface, since the support member provided around the molding surface of the lower mold supports the peripheral portion on the lower side of the molding material supplied to the molding surface of the lower mold, the molding material can be prevented from slip-off and placed at a predetermined position and such a state can be maintained without providing the elaborate movable members.

Further, the open space is ensured outward of the edge portion of the molding material supported by the support member so that the molding material can be stably supported by the support member even if there is variation in size etc. among the molding materials.

The press mold according to this invention may further comprise a sleeve allowing the upper and lower molds to be inserted thereinto from its both end sides, respectively. The sleeve regulates a horizontal relative position between the upper and lower molds.

With this configuration, since the horizontal relative position between the upper and lower molds can be regulated with high accuracy by the sleeve, the coaxiality between the upper and lower molds is enhanced so that an optical element with high eccentricity accuracy can be obtained.

In the press mold according to this invention, it is preferable that the support member is detachably provided.

With this configuration, when removing a molded article obtained by press molding from the molding surface of the lower mold, it is possible to remove the support member from the press mold along with the molded article and then detach the support member from the molded article when the temperature is lowered. Therefore, both can be easily separated from each other without increasing a molding cycle time.

In the press mold according to this invnetion, the support member may be formed in an annular shape and may be placed on a stepped portion formed around the molding surface of the lower mold at a position lower than the molding surface of the lower mold. Further, the support member may have a vent hole at a position intermediate between the molding surface of the lower mold and the stepped portion in an axial direction of the support member.

With this configuration, at the time of the press molding, an atmospheric gas existing between the molding material supported by the support member and the molding surface of the lower mold can be smoothly discharged to the outside of the press mold through the vent hole. Therefore, it is possible to prevent molded surface failure caused by the atmospheric gas staying.

It is preferable that the support member has a tapered inner periphery that reduces its inner diameter as going downward. With this configuration, a pressing load applied to the molding material can be equalized during the pressing and, further, it is not necessary to set a volume of the using molding material to be excessively large with respect to a volume of an optical element to be obtained.

An optical element manufacturing method accroding to this invention uses a press mold comprising a lower mold formed with a molding surface having a convex or flat surface and an upper mold formed with a molding surface facing the molding surface of the lower mold. In the method, a molding material is supplied to the lower mold, thereby press-molding the molding material. According to another aspect of this invention, the method comprises the steps of: supplying the molding material so that a peripheral portion of the molding material on its lower side is supported by a support member and further an open space is ensured outward of an edge portion of the molding material supported by the support member, and then causing the upper and lower molds to approach each other to thereby press-mold the molding material.

According to this method, even if the molding material has a convex curved surface while the molding surface of the lower mold has the convex or flat surface, the molding material can be stably supplied to the molding surface of the lower mold and prevented from slip-off without providing the elaborate movable members. Further, by ensuring the open space outward of the edge portion of the molding material supported by the support member, the stable support of the molding material is enabled even if there is variation in size etc. among the molding materials.

Further, it is possible to configure such that when supporting the molding material, the peripheral portion of the molding material on its lower side is supported at the ridge portion of the support member. This makes it possible to stably support the molding material even if there is variation in shape among the molding materials.

In the method according to this invention, a horizontal relative position between the upper and lower molds is regulated by a sleeve allowing the upper and lower molds to be inserted thereinto from its both end sides, respectively, thereby press-molding the molding material.

According to this method, the relative position between the upper and lower molds is regulated with high accuracy so that an optical element with higher eccentricity accuracy can be obtained.

In the method according to this invention, the molding material is supported by the support member in a non-contact state with the molding surface of the lower mold and then is press-molded.

According to this method, the molding environment where the molding material is placed can be set equal on the upper and lower sides thereof and, therefore, it is possible to avoid unequal press conditions. Further, by avoiding a reaction between the molding material and the molding surface of the lower mold at their contact interface, it is possible to prevent a disadvantage such as fusion bonding of the molding material to the molding surface of the lower mold or clouding or foaming on a molded surface of a press-molded article.

In the method according to this invention, it is preferable that the sleeve and the support member are provided with vent holes and an atmospheric gas existing between the molding material supported by the support member and the molding surface of the lower mold is discharged to the outside of the press mold through the vent holes when the upper and lower molds approach each other.

According to this method, the atmospheric gas existing between the molding material supported by the support member and the molding surface of the lower mold can be smoothly discharged to the outside of the press mold through the vent holes when the upper and lower molds approach each other. Therefore, it is possible to prevent molded surface failure caused by the atmospheric gas staying.

In the method according to this invention, it is poreferable that the molding material has a diameter larger than an optical element effective diameter.

According to this method, by setting the support position by the support member to be at the portion of the molding material outside the optical element effective diameter, the molding material can be supported more stably and the effective optical diameter of the optical element to be obtained can be ensured.

The method according to this invention may further comprise a step of carrying out a centering process for removing an outer peripheral portion of an obtained molded article after press molding.

According to this method, the centering process is applied to the press-molded article to remove a support member transferred portion thereof, thereby making the center of the outer diameter of the optical element to be obtained and its optical center coincident with each other.

The method according to this invention may still further comprise a step of removing an obtained molded article from the press mold along with the support member after press molding, and then separating the molded article and the support member from each other.

According to this method, by removing the support member from the press mold along with the press-molded article and then detaching the support member from the molded article when the temperature is lowered, both can be easily separated from each other and, further, the molding cycle time is not prolonged.

In the method according to this invention, it is preferable that the support member is used that has a tapered inner periphery which reduces its inner diameter as going downward. According to this method, a pressing load applied to the molding material can be equalized during the pressing and, further, it is not necessary to set a volume of the using molding material to be excessively large with respect to a volume of an optical element to be obtained.

In the method according to this invention, the molding material is obtained by separating a molten glass while being dropped or poured onto a receiving mold so as to be preformed, or further applying shape processing to a glass block after having been separated while being dropped or poured onto the receiving mold, so as to be preformed. Such a molding material is advantageous both in productivity and surface smoothness and, by applying it to this invention, a required optical element can be stably manufactured.

In the method according to this invention, the molding material placed inside the press mold is press-molded by transferring the press mold to a plurality of process chambers including a heating chamber, a press chamber, and a cooling chamber and applying thereto processes including heating, pressing, and cooling in the respective process chambers.

According to this method, a number of press molds can be simultaneously used while efficiently carrying out temperature rise and drop of the press molds, so that a substantial time (molding cycle time) necessary for individual molding can be shortened. Since the press mold used in the method of this invention is compact and transferable and is capable of preventing the slip-off of the molding material without providing the elaborate movable members, this manufacturing method can be suitably applied thereto.

### BRIEF DESCRIPTION OF THE DRAWINGS

FIG. 1 is a schematic sectional view showing a first embodiment of a press mold according to this invention;

FIG. 2 is a schematic plan view showing an example of a press molding machine suitable for using the press mold according to this invention;

FIGS. 3A to 3D are explanatory diagrams showing processes (1) to (4) in a first embodiment of an optical element manufacturing method according to this invention;

FIGS. 4A to 4D are explanatory diagrams showing processes (5) to (8) in the first embodiment of the optical element manufacturing method according to this invention;

FIGS. 5A to 5D are explanatory diagrams showing processes (9) to (12) in the first embodiment of the optical element manufacturing method according to this invention;

FIGS. 6A and 6B are explanatory diagrams showing processes (13) and (14) in the first embodiment of the optical element manufacturing method according to this invention;

FIGS. 7A and 7B are explanatory diagrams showing processes, corresponding to FIGS. 5B and 5C, in another embodiment of an optical element manufacturing method according to this invention; and

FIGS. 8A and 8B are explanatory diagrams showing processes, corresponding to FIGS. 6A and 6B, in the other embodiment of the optical element manufacturing method according to this invention.

### DESCRIPTION OF THE PREFERRED EMBODIMENTS

Now, referring to the drawings, description will be made about preferred embodiments of a press mold and an optical element manufacturing method according to this invention.

[Press Mold]

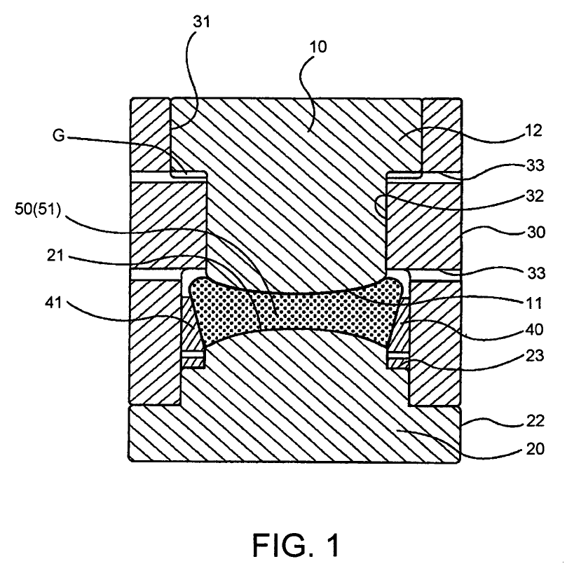

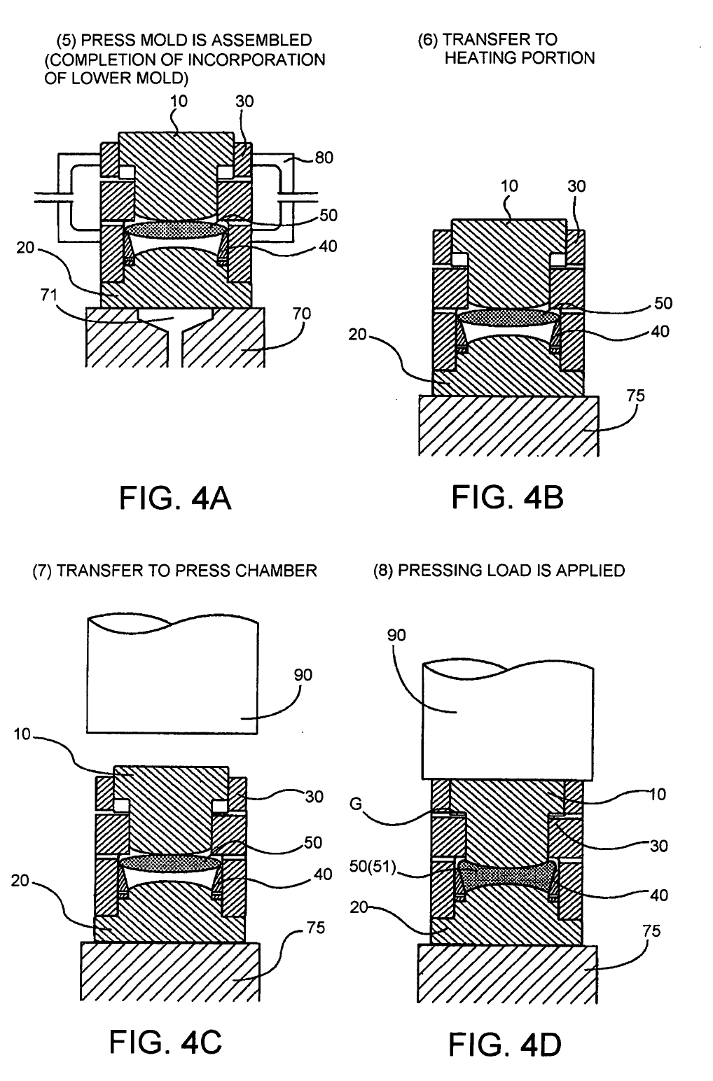

At first, the embodiment of the press mold according to this invention will be described with reference to FIG. 1. FIG. 1 is a schematic sectional view of the press mold according to this embodiment and shows the state at the time of application of a pressing load (see FIG. 4D, (8)).

The press mold shown in FIG. 1 comprises an upper mold 10, a lower mold 20, a sleeve 30, and a support member 40 and is adapted to press-mold a molding material 50 between the upper mold 10 and the lower mold 20.

In this embodiment, the sleeve 30 serves to slidingly guide the upper and lower molds 10 and 20 so as to regulate the relative position between them in the horizontal direction at the time of assembly of the press mold and at the time of press molding, thereby ensuring coaxiality between the upper and lower molds 10 and 20. That is, the sleeve 30 directly contacts the upper and lower molds 10 and 20 and slidingly guides them, respectively, while a clearance at each of contact portions therebetween is controlled at a sufficiently small value, so that it is possible to achieve strict coaxiality between the upper and lower molds 10 and 20.

Accordingly, in consideration of required eccentricity accuracy of an optical element, the sliding clearance between the sleeve 30 and the upper and lower molds 10 and 20 is preferably set to 10 μm or less and particularly 5 μm or less. By controlling the sliding clearance, the eccentricity between molding surfaces 11 and 21 of the upper and lower molds 10 and 20 (shift: offset between the molding surfaces 11 and 21 of the upper and lower molds 10 and 20 in the horizontal direction; tilt: inclination between axes of the upper and lower molds 10 and 20) can be suppressed with high accuracy. Particularly, in this embodiment, the sleeve 30 contacts and surrounds the outer periphery of the molding surface 11 of the upper mold 10 and the vicinity of the outer periphery of the molding surface 21 of the lower mold 20 to thereby carry out positioning of them and, therefore, it is possible to suppress the position offset (shift) between the upper and lower molds 10 and 20. That is, the support member 40 is disposed as will be described later so that the sleeve 30 can highly maintain the coaxiality between the upper and lower molds 10 and 20.

In this embodiment, it is configured such that, at the time of press molding, the upper mold 10 is slidingly guided in the sleeve 30 with respect to the lower mold 20 fitted in the sleeve 30, thereby allowing the upper and lower molds 10 and 20 to approach and separate from each other. However, it may be configured otherwise. That is, it may be configured such that the lower mold 20 is slidingly guided in the sleeve 30 with respect to the upper mold 10 fitted in the sleeve 30. As long as the upper and lower molds 10 and 20 are allowed to approach and separate from each other while ensuring the coaxiality therebetween, there is no limitation to its specific structure.

In order to prevent that the movement of the upper and lower molds 10 and 20 is obstructed due to a difference in atmospheric pressure between the inside and outside of the press mold when the upper and lower molds 10 and 20 approach and separate from each other, it is preferable that the sleeve 30 be provided with vent holes 33. Particularly, in this embodiment, it is preferable that, as shown in FIG. 1, the vent holes 33 be provided at the positions where the inner diameter of the sleeve 30 changes to form stepped portions, so that the inside of the press mold is constantly equal in pressure to the external pressure by conduction of an atmospheric gas through the vent holes 33 with respect to changes in volume of gaps at the stepped portions. Further, it is preferable that the support member 40 be also provided with vent holes 41 for the same purpose as in the case of the sleeve 30. This makes it possible to smoothly carry out press molding and assembly/disassembly of the press mold.

The upper mold 10 is formed with the molding surface 11 on its lower side facing the lower mold 20. In the example shown in FIG. 1, the molding surface 11 is formed as a convex surface, but it may be a concave or flat surface. In the upper part of the upper mold 10 is formed a flange portion 12 having a diameter larger than that of the molding surface 11. This flange portion 12 is received in a large-diameter inner peripheral portion 31 formed in the upper part of the sleeve 30.

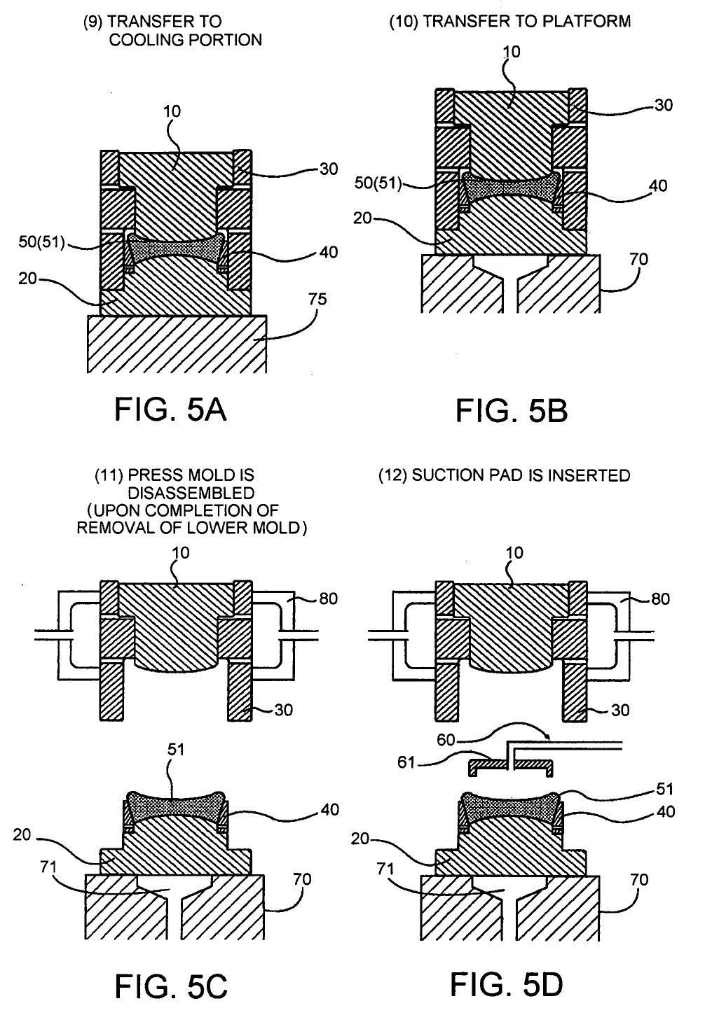

It is preferable that when an upper surface of the upper mold 10 becomes flush with an upper surface of the sleeve 30, a gap G equal to or greater than a predetermined dimension be ensured between a lower surface of the flange portion 12 of the upper mold 10 and an upper end of a small-diameter inner peripheral portion 32 of the sleeve 30. By ensuring such a gap G, even after pushing the upper mold 10 at the time of press molding so that the upper surface of the upper mold 10 becomes flush with the upper surface of the sleeve 30 to once determine the thickness of a molded article 51, it is possible to continue applying a required load (only the self weight of the upper mold 10 may be enough) to the molded article 51 and thus allow the upper mold 10 to descend following thermal contraction of the molded article 51 (see FIG. 4D, (8) and FIG. 5A, (9)).

In the example shown in FIG. 1, the lower mold 20 is formed with the molding surface 21 on its upper side facing the upper mold 10 and this molding surface 21 has a convex surface. However, the molding surface 21 of the lower mold 20 may have a flat surface. In the lower part of the lower mold 20 is formed a flange portion 22 having a diameter larger than that of the molding surface 21. At the time of the press molding, a lower surface of the sleeve 30 contacts an upper surface of the flange portion 22 and, further, both are tightly abutted to each other by the pressing pressure, so that the relative position between the lower mold 20 and the sleeve 30 is defined with high accuracy. This also serves to suppress the tilt.

Further, around the molding surface 21 of the lower mold 20, a stepped portion 23 is formed at a position lower than the molding surface 21 and higher than the flange portion 22. The annular support member 40 is disposed on the stepped portion 23 so as to surround the outer periphery of the molding surface 21.

The support member 40 serves to support the molding material 50 supplied on the lower mold 20 to thereby prevent slip-off and position offset of the molding material 50. There is no particular limitation to a specific structure as long as it can support a peripheral portion of the molding material 50 on its lower side and ensure an open space outward of an edge portion of the molding material 50 supported by the support member 40. By ensuring the open space outward of the edge portion of the molding material 50 supported by the support member 40, it is possible to stably support the molding material 50 and maintain such a state even if there is variation in maximum outer diameter among the molding materials 50 each supplied onto the lower mold 20 due to individual differences thereof or even if the horizontal section of the molding material 50 is not completely rounded so that there is a difference in diameter depending on a portion of the molding material 50.

Herein, the open space is only required to be a space that can allow the individual difference of the molding material 50, and may be accommodated in the sleeve 30 after the upper and lower molds 10 and 20 have been assembled together.

The support member 40 held on the stepped portion 23 preferably has an outer diameter equal to or smaller than that of a portion (a sliding portion with the sleeve 30) of the lower mold 20. This prevents the support member 40 from impeding the sliding guide of the lower mold 20 by the sleeve 30, thereby ensuring the coaxiality between the upper and lower molds.

Herein, “support” represents allowing the molding material 50 to maintain its constant posture. Further, the position where the molding material 50 is supported by the support member 40 (i.e. the peripheral portion of the molding material 50 on its lower side) is determined in consideration of capability of stably supporting the molding material 50 and further in consideration of an effective optical diameter of an optical element such as a lens to be obtained and preferably a centering diameter (an outer diameter of a final optical element after having been applied with a process of cutting off the outer periphery of the press-molded article 51 to thereby make the center of its outer diameter consistent with the optical center, i.e. the centering process, which is also called an optical element effective diameter). It is preferable that the following relational expression (1) be satisfied.
[Effective Optical Diameter]≦[Optical Element Effective Diameter (=Centering Diameter)]<[Inner Diameter of Support Member (Support Position)]<[Diameter of Molding Material] (1)

More specifically, use is preferably made of the molding material 50 having the maximum outer diameter larger than the optical element effective diameter and, given that the maximum outer diameter of the molding material 50 is 2r, the position of supporting the molding material 50 is preferably set in the range of 0.5 to 0.95r and more preferably in the range of 0.7 to 0.95r from the center of the molding material 50. This can reduce the removal ratio in the centering process of the molded article 51 and thus enables the efficient production.

The support member 40 may be formed integrally with or separately from the lower mold 20. When the support member 40 is formed separately from the lower mold 20, the support member 40 can be fixed to the lower mold 20 by the use of pins or the like. However, like in the example shown in FIG. 1, the support member 40 is preferably provided so as to be detachable with respect to the lower mold 20. In order to detachably provide the separately formed support member 40 around the molding surface 21 of the lower mold 20, the stepped portion 23 may be formed around the molding surface 21 of the lower mold 20 at the position lower than the molding surface 21 and higher than the flange portion 22 and the support member 40 may be placed on the stepped portion 23 as shown in FIG. 1, for example.

In this event, the vent holes 41 of the support member 40 are provided at the positions where the molding material 50 is prevented from entering the vent holes 41 during the press molding. Specifically, it is preferable that, in the state where the support member 40 is placed on the stepped portion 23, the vent holes 41 be provided at the positions intermediate between the rim portion of the molding surface 21 of the lower mold 20 and the stepped portion 23 in the axial direction of the support member 40.

In the example shown in FIG. 1, the vent holes 41 are provided so as to pass through the support member 40 substantially in the radial directions and communicate with the clearance between the inner peripheral surface of the support member 40 and the lower mold 20, the clearance between the outer peripheral surface of the support member 40 and the sleeve 30, and the vent holes 33 of the sleeve 30. With this configuration, when the atmospheric gas existing in a space between the molding material 50 and the molding surface 21 of the lower mold 20 is compressed by the approach of the upper and lower molds 10 and 20 therebetween (press molding), the atmospheric gas in the press mold can be discharged to the outside of the press mold through the clearance between the inner peripheral surface of the support member 40 and the lower mold 20, the vent holes 41 of the support member 40, the clearance between the outer peripheral surface of the support member 40 and the sleeve 30, and then the vent holes 33 of the sleeve 30.

Therefore, by providing such vent holes 41 to discharge the atmospheric gas to the outside of the press mold, it is possible to keep the balance in pressure between the inside and outside of the press mold.

As will be described later, the clearance between the outer peripheral surface of the support member 40 and the sleeve 30 does not directly influence the eccentricity accuracy of the optical element to be formed and thus can be set to a value that can establish communication between the vent holes 41 of the support member 40 and the vent holes 33 of the sleeve 30 so as to allow the atmospheric gas to be smoothly discharged.

By setting the support member 40 to be detachable with respect to the lower mold 20, when removing the molded article 51 from the molding surface 21 of the lower mold 20 after the press molding, it is possible to remove the support member 40 along with the molded article 51. Accordingly, by removing the molded article 51 and the support member 40 from the press mold after the press molding while both are adhering to each other and then detaching the support member 40 from the molded article 51 when the temperature is lowered, both can be easily separated from each other.

It is preferable that the inner periphery of the support member 40 be tapered so as to form an inclined surface that reduces its inner diameter as going downward (as approaching the molding surface 21 of the lower mold 20). This makes it possible to avoid occurrence of filling failure or pressing failure at a portion along the outer periphery of the molding surface 21 during the press molding. Accordingly, in order to prevent an excessive increase in using amount (volume) of the molding material 50 caused by increasing the outer diameter of the molding material 50 more than necessary so as to ensure the optical element effective diameter, it is effective to form such a slope on the inner periphery of the support member 40.

Since the clearance between the support member 40 and the sleeve 30 has no direct relationship to the eccentricity accuracy of the optical element, it may be set to about 5 to 50 μm and the coincidence between the center of the outer diameter of the optical element to be obtained and its optical axis can be achieved by applying the centering process to the molded article 51 after the press molding.

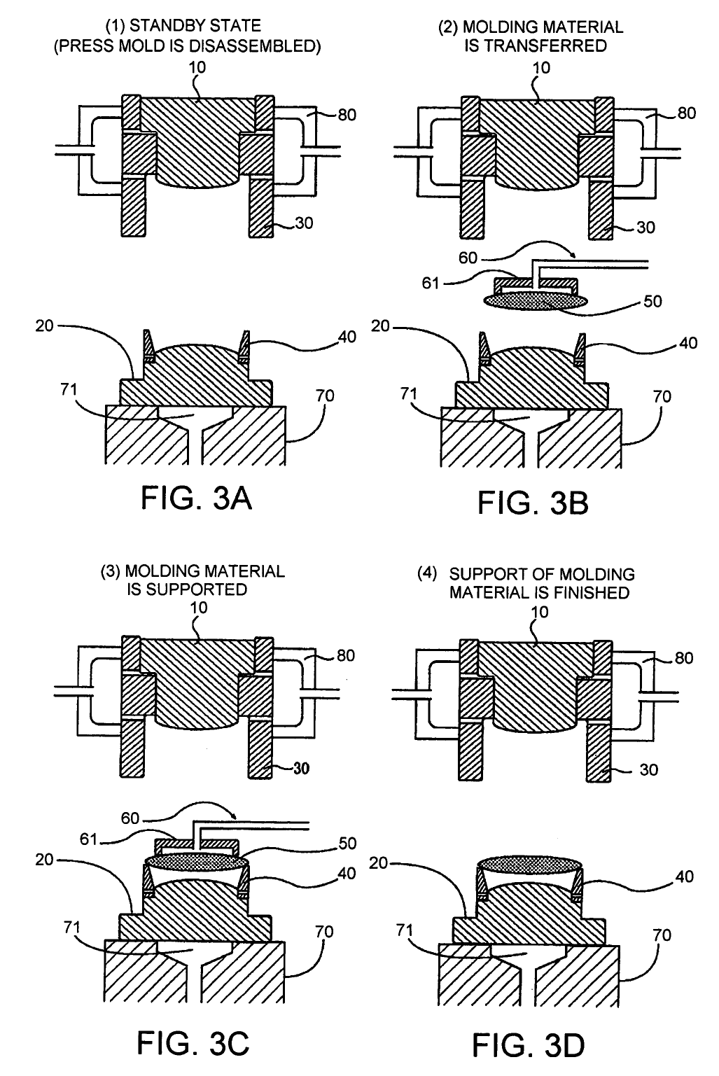

The shape and size of the support member 40 are not particularly limited as long as the upper end side of the support member 40 projects above the molding surface 21 of the lower mold 20 such that the peripheral portion, on the lower side, of the molding material 50 supplied to the lower mold 20 is sufficiently supported at least on the upper edge of the support member 40 on its inner peripheral side (see FIG. 3D, (4)).

In this event, the molding material 50 may be in the state where it is in contact with the molding surface 21 of the lower mold 20 or in the state where it is not in contact with the molding surface 21 of the lower mold 20 and is supported only by the support member 40. Particularly, when press molding is carried out by using the press mold according to this embodiment in a later-described molding machine, since the press mold containing the molding material 50 therein is heated along with the molding material 50, if the molding material 50 and the press mold (the molding surface 21 of the lower mold 20) are in contact with each other, a reaction may occur between them at their interface to cause fusion bonding of the molding material 50 to the molding surface 21 or clouding or foaming on the molded surface of the molded article 51. Further, it is preferable that the molding conditions do not differ between the upper and lower sides of the molding material. Therefore, the upper end side of the support member 40 preferably projects above the molding surface 21 of the lower mold 20 such that the molding material 50 can be supported by the support member 40 so as not to contact the molding surface 21 of the lower mold 20.

This is particularly effective when the lower mold 20 tends to be heated more strongly due to the heat capacity of a holding stage 75 in the later-described molding machine.

The shape of the portion (the upper edge on the inner peripheral side) of the supporting member 40 that supports the molding material 50 may be an angular shape, an R-chamfered shape, or a C-chamfered shape. Alternatively, it may be a curved surface shape that follows the curved surface of the molding material 50. The manner of supporting the molding material 50 at the ridge portion of the support member 40 is preferable because it can cope with variation in shape among the molding materials 50. Further, when supporting the molding material 50, the support member 40 is not necessarily in contact with the molding material 50 over the entire circumference thereof, but may support the molding material 50 by partial contact with the molding material 50 at predetermined intervals in the circumferential direction.

The size of the support member 40 is determined in consideration of the following points. When the height of the support member 40 is too large, there arises a disadvantage that the portion, projecting above the molding surface 21 of the lower mold 20, of the support member 40 becomes too high and, therefore, at the time of press molding, the height (sliding guide length) of the large-diameter inner peripheral portion 31 and small-diameter inner peripheral portion 32 of the sleeve 30 that serve to slidingly guide the upper mold 10 becomes relatively smaller so that it is difficult to obtain required eccentricity (particularly, tilt) accuracy of a molded article. This is because since the tilt angle of the upper mold 10 allowed within the sleeve 30 is determined by the sliding clearance between the sleeve 30 and the upper mold 10 and the sliding guide length, if the sliding clearance is constant, the tilt of the upper mold 10 is suppressed to make excellent the coaxiality between the upper and lower molds 10 and 20 to thereby enhance the eccentricity accuracy of the molded article as the optical element as the sliding guide length increases, while, such an effect of suppressing the tilt of the upper mold 10 is reduced as the sliding guide length decreases.

Therefore, it is preferable that the height of the portion of the support member 40 projecting above the molding surface 21 of the lower mold 20 be set as low as possible in a range not impeding the press molding in terms of relationship with the shape, size, etc. of the molded article 51 to be obtained, taking into account the sliding guide length in the sleeve 30. For example, given that the thickness of the outer peripheral portion of the molded article 51 to be obtained is h, the height of the portion of the support member 40 projecting above the molding surface 21 of the lower mold 20 is preferably greater than 0.9h and less than 1.2h.

The fact that the support member 40 is not too high is also advantageous in that when supplying the glass material onto the lower mold 20 with the support member 40 disposed thereon and when removing the molded article after the press molding, it is possible to avoid interference with a robot or the like that sucks and transfers the glass material or the molded article.

In this invention, there is no particular limitation to a material of the upper mold 10, the lower mold 20, the sleeve 30, and the support member 40. There can be cited a cermet of silicon carbide, silicon, silicon nitride, tungsten carbide, aluminum oxide, or titanium carbide, or the cermet of which the surface is coated with a diamond, a heat-resistant metal, a noble metal alloy, a carbide, a nitride, a boride, an oxide, or the like.

As each of the molding surfaces 11 and 21 of the upper and lower molds 10 and 20 and the support member 40, use is preferably made of a carbon film in the form of a single-component layer or a composite layer of amorphous and/or crystalline graphite and/or diamond, a mold release film of noble metal alloy, or the like in order to prevent fusion bonding of the glass.

There is no particular limitation to a material for the molding material 50 for use in this invention. For example, it may be a glass material such as a glass preform.

The molding material 50 may be obtained by, for example, preforming (hot-forming) an optical glass into a spherical shape, a convex-convex curved shape (a shape with convex curved surfaces on both sides), a flat-convex shape, or the like wherein the optical glass in a molten state is separated while being dropped or poured onto a receiving mold so as to be formed into such a shape, or further applying shape processing by hot-forming to a glass block after having been separated while being dropped or poured onto the receiving mold. In this invention, the molding material having the convex curved surface is preferably used and the molding material having the convex-convex curved shape is particularly preferable.

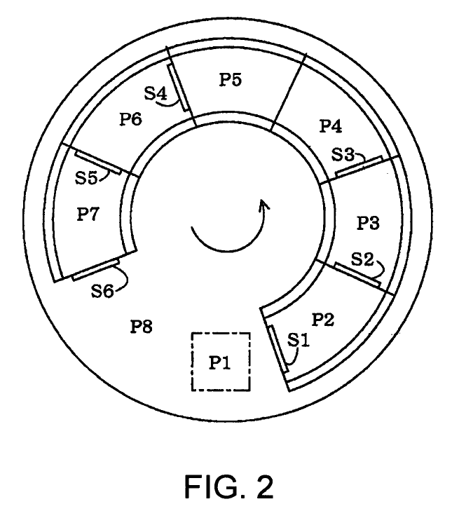

Now, referring to FIG. 2, description will be made about a press molding machine suitable for carrying out the press molding by the use of the press mold according to this invention. FIG. 2 is a schematic plan view of a rotary transfer molding machine shown as one example of such a press molding machine.

The molding machine shown in FIG. 2 comprises a removal/reception chamber P1 and process chambers P2 to P8 arranged in the circumferential direction.

Removal of a press mold that has finished molding and reception of a press mold containing therein a molding material newly subjected to molding are carried out in the removal/reception chamber P1. A press mold received in the removal/reception chamber P1 passes through the inside of each of the process chambers P2 to P8 in order while being held on a holding stage attached to a rotary table rotating in an arrow direction in the figure and containing therein a molding material (or a molded article). The inside of each of the process chambers P2 to P8 is constantly in an atmosphere of non-oxidizing gas (inert gas). The rotary table is intermittently rotated per a fixed time and, by this intermittent rotation, the press mold is moved between the adjacent process chambers. Such a fixed time is defined as a molding cycle time.

Herein, P2 denotes a first heating chamber, P3 a second heating chamber, and P4 a third heating chamber (or a soaking chamber), which are also collectively called a heating portion. P5 denotes a press chamber where a pressing load is applied to the press mold that has been controlled to a temperature suitable for press molding at the heating portion. P6 denotes a first annealing chamber, P7 a second annealing chamber, and P8 a quenching chamber, which are also collectively called a cooling portion where a cooling process is applied to the press mold after having been applied with the pressing load. These process chambers P2 to P8 are arranged at substantially regular intervals and controlled at predetermined temperatures suitable for the respective processes. In order to maintain the respective process chambers at the predetermined temperatures, the process chambers are partitioned by shutters S1 to S6.

By the use of the molding machine as shown in FIG. 2, required optical elements can be efficiently manufactured by applying the proper processes to a plurality of press molds each containing therein a molding material (or a molded article), while transferring them to the respective process chambers in sequence.

That is, since the temperature rise of the press mold to the temperature suitable for the press molding, the application of the pressing load to the press mold, and the cooling process for the press mold thereafter are carried out while the press molds pass through the respective process chambers arranged two-dimensionally, the press molds in large number can be simultaneously used so that a substantial time (molding cycle time) necessary for individual molding is shortened.

As described above, the time required for the press mold to move between the adjacent process chambers by the intermittent rotation of the rotary table is defined as the molding cycle time.

The press mold according to this invention is suitably used in the molding machine wherein the press mold containing therein the molding material (or the molded article) is transferred to the respective process chambers such as the heating chambers, the press chamber, and the cooling chambers, thereby applying thereto the proper processes including the heating, the pressing, and the cooling in sequence. However, the specific structure of such a molding machine is not limited to the foregoing example. For example, in the foregoing example, the press mold is transferred by the use of the rotary table. However, there is no particular limitation to press mold transfer means as long as it is configured such that the press mold can pass through two-dimensionally (or three-dimensionally if necessary) arranged process chambers at a predetermined time interval, respectively.

Further, the arrangement of the respective process chambers can be properly changed for optimizing the heating process and the cooling process in terms of the composition of a molding material and the shape of a molded article to be obtained. For example, it is possible to provide four heating chambers and three cooling chambers. Moreover, in order to further improve the production efficiency, heating chambers, press chambers, cooling chambers, and so on are parallelly arranged in the same numbers to thereby concurrently carry out a plurality of kinds of press molding that require different temperature conditions and different pressing conditions.

On the other hand, in order to improve the production efficiency, it is possible to simultaneously process a plurality of press molds in each of process chambers by, for example, causing a plurality of holding stages serving for the same process to simultaneously pass through each of the process chambers. Specifically, when the processes such as heating, application of a pressing load, and cooling are carried out in the respective process chambers, two or more press molds are arranged in a moving direction in each of the process chambers, thereby simultaneously applying the same process to the press molds. In this case, it is preferable to provide two or more press means arranged in the moving direction in the press chamber.

[Optical Element Manufacturing Method]

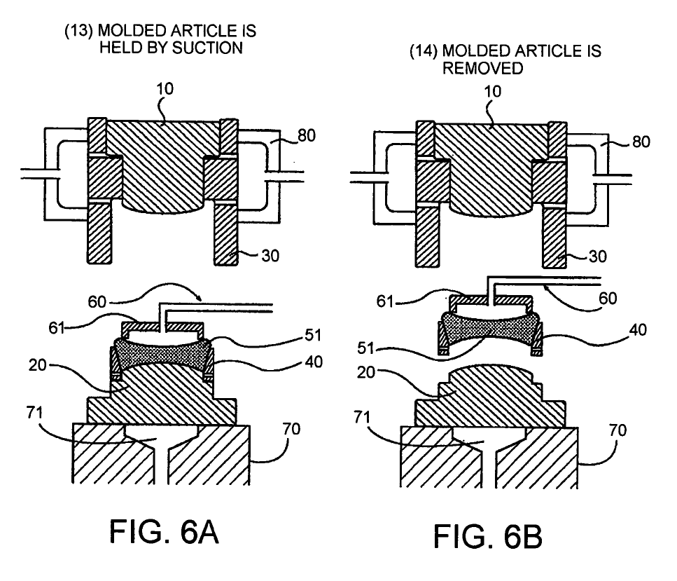

Now, the embodiment of the optical element manufacturing method according to this invention will be described with reference to FIGS. 3A to 6B in terms of an example where the press mold shown in FIG. 1 is applied to the molding machine shown in FIG. 2. FIGS. 3A to 3D are explanatory diagrams showing processes (1) to (4) in the optical element manufacturing method according to this embodiment, FIGS. 4A to 4D are explanatory diagrams showing processes (5) to (8) in the same method, FIGS. 5A to 5D are explanatory diagrams showing processes (9) to (12) in the same method, and FIGS. 6A and 6B are explanatory diagrams showing processes (13) and (14) in the same method.

Processes (1) to (4): Molding Material Supply Process

With respect to the press mold that is in a standby state where the lower mold 20 and the upper mold 10 are separated from each other (see FIG. 3A, (1)), a molding material (e.g. a glass preform) 50 preformed into the shape with the convex curved surface (the convex-convex curved shape in the shown example) is supplied by the use of a transfer arm 60 with a suction pad 61 (see FIG. 3B, (2)). When the suction pad 61 reaches a position just above the molding surface 21 of the lower mold 20 with accuracy in a predetermined range (see FIG. 3C, (3)) and releases its suction, the peripheral portion of the molding material 50 on its lower side is supported on the upper edge of the support member 40 on its inner peripheral side so that the molding material 50 is held on the support member 40 while being prevented from slip-off (see FIG. 3D, (4)).

In this event, as shown in FIG. 3D, (4), the molding material 50 supported by the support member 40 does not contact any other portions of the press mold and the open space is ensured outward of the edge portion of the molding material 50. The molding material 50 is supported by the support member 40 in a non-contact state with the molding surface 21 of the lower mold 20 and this state is maintained up to a later-described pressing process.

Further, the molding material 50 has a diameter larger than an outer diameter (optical element effective diameter) of an optical element to be obtained and, by supporting the molding material 50 at its portion (the peripheral portion on the lower side) outside the optical element effective diameter by the use of the support member 40, the molding material 50 can be supported more stably and the outer diameter of the optical element to be obtained can be ensured.

When supplying the molding material 50, it is preferable that the operation of the transfer arm 60 be controlled so as to place the molding material 50 on the molding surface 21 of the lower mold 20 in the state where positioning between the center of the suction pad 61 and the center of the molding material 50 is carried out in advance to make them coincident with each other and further in the state where the center of the suction pad 61 and the center of the molding surface 21 of the lower mold 20 substantially coincide with each other. The transfer arm 60 is retreated immediately after supplying the molding material 50. On the other hand, the sleeve 30 having the upper mold 10 incorporated therein is fixed in position by holding means 80.

Process (5): Press Mold Assembly Process

After the molding material 50 is held on the support member 40, a platform 70 is moved upward so that the lower mold 20 is incorporated into the sleeve 30 (see FIG. 4A, (5)). In this event, the clearance between the sleeve 30 and the lower mold 20 is preferably set to 5 μm or less. Further, the clearance between the upper mold 10 and the sleeve 30 assembled together in advance is also preferably set to the same value. This makes it possible to suppress the eccentricity between the molding surfaces 11 and 21 of the upper and lower molds 10 and 20 with high accuracy.

When the lower mold 20 has been incorporated into the sleeve 30 so that the upper surface of the flange portion 22 of the lower mold 20 is brought into contact with the lower surface of the sleeve 30, the upper surface of the upper mold 10 is pushed upward to a position higher than the upper surface of the sleeve 30 due to the thickness of the molding material 50 as shown in FIG. 4A, (5).

When assembling the press mold, the upper mold 10 and the sleeve 30 may be moved downward by the use of the holding means 80 instead of moving the platform 70 upward.

In the foregoing processes (1) to (5), in order to prevent occurrence of position offset of the lower mold 20 on the platform 70, it is possible to tightly abut and fix the lower mold 20 on the platform 70 by sucking an atmospheric gas through an opening 71 formed in the platform 70. As will be described later, when disassembling the press mold, it is possible to avoid offset of the horizontal relative position between the lower mold 20 and the sleeve 30 by tightly abutting and fixing the lower mold 20 on the platform 70 by sucking the atmospheric gas so as to maintain the position when the lower mold 20 is pulled out of the sleeve 30.

The press mold that has been assembled, with the molding material 50 received therein, according to the foregoing processes (1) to (5) is inserted into the molding machine shown in FIG. 2 from the removal/reception chamber P1. However, the foregoing processes (1) to (5) may be carried out in the removal/reception chamber P1.

Process (6): Heating Process

The press mold having the molding material 50 therein and inserted into the molding machine is held on a holding stage 75 attached to the rotary table and then heated while being transferred to the heating chambers P2 to P4 in sequence (see FIG. 4B, (6)). By this, the press mold in whole is heated to a temperature suitable for press molding the molding material 50.

In this event, for example, the first heating chamber P2 is maintained at a high temperature above the pressing temperature of the molding material 50, thereby rapidly heating the press mold and the molding material 50. Then, the press mold having the molding material 50 therein is stopped for a predetermined time in the first heating chamber P2 and, thereafter, transferred to the second heating chamber P3 according to the rotation of the rotary table. In the second heating chamber P3, the press mold and the molding material 50 are soaked so as to approach the pressing temperature while being further heated. Then, in the third heating chamber P4, the press mold and the molding material 50 are soaked so that the molding material 50 has a viscosity of 106 to 109 pores suitable for the press molding. Preferably, the temperature of the molding material 50 is set to a value where the viscosity of the molding material 50 becomes 106 to 108 pores.

There is no particular limitation to heating means provided in the heating chambers P2 to P4. For example, use can be made of an ohmic-resistance heater, a high-frequency induction coil, or the like.

Processes (7) and (8): Pressing Process

The press mold controlled at the proper temperature is transferred to the pressing chamber P5 (see FIG. 4C, (7)). In the pressing chamber P5, the pressing load is applied to the press mold from above it by a press head 90 with a predetermined pressure (e.g. 30 to 200 Kg/cm²) for a predetermined time (e.g. several tens of seconds) (see FIG. 4D, (8)). In this event, the atmospheric gas existing between the lower mold 20 and the molding material 50 is discharged to the outside of the press mold through the vent holes 41 of the support member 40 and the vent holes 33 of the sleeve 30.

At the time instant when the lower surface of the press head 90 is brought into contact with the upper surface of the sleeve 30, the thickness of the molded article 51 is defined and, thereafter, the press head 90 is moved upward to release the application of the pressing load, thereby finishing the pressing process.

Process (9): Cooling Process

After the pressing process is finished, the press mold is transferred to the annealing chambers P6 and P7 and the quenching chamber P8 in sequence where the cooling process is carried out (see FIG. 5A, (9)).

In the quenching chamber P8, rapid quenching is carried out to cool the molded article 51 to a temperature equal to or less than a glass transition point. In this event, by ensuring the foregoing gap G of the predetermined dimension between the lower surface of the flange portion 12 of the upper mold 10 and the upper end of the small-diameter inner peripheral portion 32 of the sleeve 30, the upper mold 10 is allowed to descend following contraction of the glass by its self weight so that excellent shape accuracy can be obtained.

When the upper mold 10 descends following the contraction of the glass, the gap G between the lower surface of the flange portion 12 of the upper mold 10 and the upper end of the small-diameter inner peripheral portion 32 of the sleeve 30 is narrowed.

Processes (10) and (11): Press Mold Disassembly Process

When the press mold is returned to the removal/reception chamber P1, the press mold is removed to the outside of the molding machine. Then, disassembly of the press mold, removal of the molded article 51, and, further, supply of a new molding material 50 are carried out.

In the mold press disassembly process, the press mold containing the molded article 51 therein is transferred to the platform 70 by the use of a robot (see FIG. 5B, (10)) and locked in position by chucking the outer periphery thereof. Subsequently, the atmospheric gas is sucked through the opening 71 of the platform 70 to thereby hold the lower mold 20 integrally on the platform 70. Then, the platform 70 is moved vertically downward to pull the lower mold 20 out of the sleeve 30, thereby separating the upper mold 10 and the lower mold 20 from each other (see FIG. 5C, (11)). When pulling the lower mold 20 out of the sleeve 30, it is possible to avoid offset of the horizontal relative position between the lower mold 20 and the sleeve 30 by holding the lower mold 20 integrally on the platform 70 so as to maintain the position when the lower mold 20 is pulled out of the sleeve 30.

In this event, like in the foregoing molding material supply process and press mold assembly process, the sleeve 30 having the upper mold 10 incorporated therein is fixed in position by the holding means 80.

In the removal/reception chamber P1 that is not in the inert gas atmosphere, a temperature control is preferably executed so as to cause the temperature of the press mold to be equal to or less than 250° C. in terms of preventing oxidation of the press mold.

Processes (12) to (14): Optical Element Removal Process

After pulling the lower mold 20 out of the sleeve 30, the transfer arm 60 is inserted between the upper and lower molds 10 and 20 (see FIG. 5D, (12)). Then, by the use of the suction pad 61 at the tip of the transfer arm 60, the molded article 51 is held by suction (see FIG. 6A, (13)) and then removed from the molding surface 21 of the lower mold 20 (see FIG. 6B, (14)).

In this event, since the support member 40 is provided so as to be detachable with respect to the lower mold 20, the support member 40 can be removed along with the molded article 51. By removing the molded article 51 and the support member 40 from the press mold while both are adhering to each other and then detaching the support member 40 from the molded article 51 when the temperature is lowered, both can be easily separated from each other. Then, by applying the centering process to the separated molded article 51 according to necessity so as to make the center of the outer diameter of the optical element and its optical center coincident with each other, the required optical element can be obtained.

In the case where the support member 40 is removed from the press mold along with the molded article 51 as described above, a plurality of support members 40 are prepared and the support member 40 is supplied on the lower mold 20 prior to the molding material supply process (the foregoing processes (1) to (4)).

After the foregoing processes (1) to (14) have been finished, the support member 40 is supplied on the lower mold 20 according to necessity and then the optical element manufacturing method returns to the process (1) to repeat the foregoing cycle so that the press molding can be carried out continuously.

According to the optical element manufacturing method of this embodiment as described above, the molding material is supplied to the molding surface of the lower mold such that the peripheral portion of the molding material on its lower side is supported by the support member and, therefore, it is possible to hold the molding material in the state where the molding material is securely disposed at the predetermined position without causing the slip-off or position offset even if the molding surface of the lower mold has the convex or flat surface. Further, the open space is ensured outward of the edge portion of the molding material supported by the support member so that the stable support of the molding material is enabled even if there is variation in size among the molding materials. This makes it possible to prevent the thickness deviation in the press molding so that the surface accuracy of the optical element to be obtained becomes excellent.

If the molding material 50 is in contact with the molding surface 21 of the lower mold 20, when use is made of the foregoing rotary transfer molding machine, the contact time between them tends to be long so that the reaction is liable to occur between them at their contact interface. On the other hand, in this embodiment, since the molding material 50 is transferred to the pressing process in the non-contact state with the molding surface 21 of the lower mold 20, such a problem can be effectively avoided. Particularly, it is quite effective when press molding is carried out by the use of a highly reactive glass material, such as a phosphate-based glass material, a glass material containing a large amount of a high refractive index component (e.g. nd≧1.7) such as W, Ti, or Nb, or a glass material containing a large amount of alkali metal.

Further, since the molding material 50 placed inside the press mold is press-molded by transferring the press mold to the plurality of process chambers including the heating chambers, the press chamber, and the cooling chambers and applying thereto the processes including the heating, pressing, and cooling in the respective process chambers, the press molds in large number can be simultaneously used while efficiently carrying out temperature rise and drop of the press molds, so that the substantial time (molding cycle time) necessary for individual molding can be shortened. Since the press mold in this embodiment is capable of regulating the slip-off of the molding material 50 without providing the elaborate movable members, such a manufacturing method can be suitably applied thereto.

While this invention has been described in terms of the preferred embodiments, the invention is not to be limited thereto, but can be embodied in various ways within the scope of this invention.

For example, it is possible to provide suction vent holes 24 each establishing communication between the bottom surface of the lower mold 20 and the stepped portion 23 having the support member 40 disposed thereon and tightly abut the support member 40 to the lower mold 20 by sucking the atmospheric gas through the suction vent holes 24. By configuring that the support member 40 and the lower mold 20 are tightly abutted to each other by the suction of the atmospheric gas as described above, it is possible to prevent the molded article 51 and the support member 40 from adhering to the upper mold 10 side at the time of disassembling the press mold to separate the upper and lower molds 10 and 20 from each other by the use of the simple structure of only providing the suction vent holes 24 and, further, at the time of removing the molded article 51, it is possible to separate only the molded article 51 from the lower mold 20 and the support member 40 and take it out.

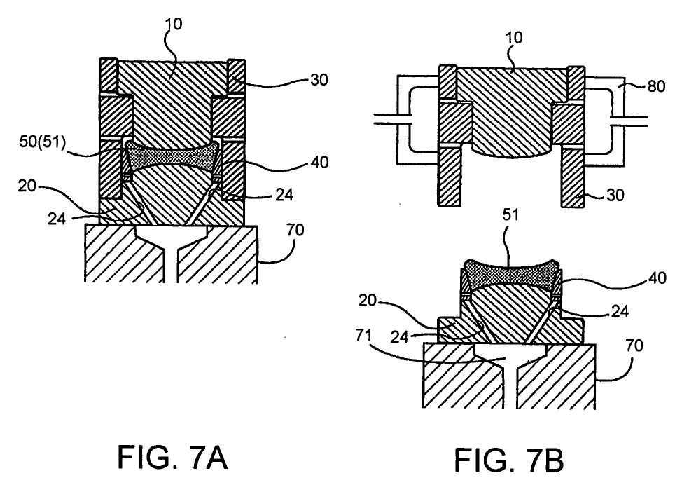

Specifically, as shown in FIGS. 7A and 7B, the lower mold 20 is provided therein with the suction vent holes 24 each establishing communication between the bottom surface of the lower mold 20 and the stepped portion 23. Then, in the press mold disassembly process, the platform 70 is moved vertically downward while sucking the atmospheric gas through the opening 71 of the platform 70 so as to simultaneously hold the lower mold 20 and the support member 40 by the suction. Accordingly, it is possible to pull the lower mold 20, the support member 40, and the molded article 51 out of the sleeve 30 in the state where they are held together on the platform 70. This makes it possible to prevent the molded article 51 from adhering to the molding surface 11 of the upper mold 10 at the time of disassembling the press mold.

Herein, FIGS. 7A and 7B are explanatory diagrams respectively corresponding to FIGS. 5B, (10) and 5C, (11) showing the press mold disassembly process.

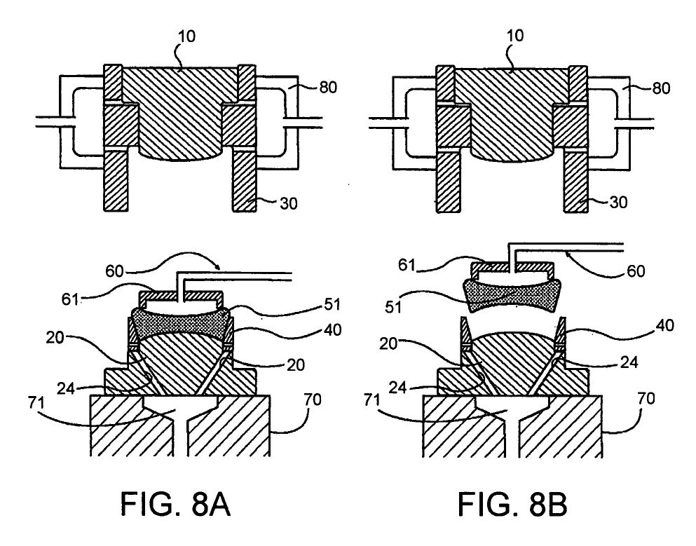

Further, as shown in FIGS. 8A and 8B, when removing the molded article 51 from the lower mold 20 in the optical element removal process, it is possible to tightly abut the support member 40 and the lower mold 20 to each other by sucking the atmospheric gas through the suction vent holes 24. This makes it possible to remove only the molded article 51 from the molding surface 21 of the lower mold 20 by the use of the suction pad 61.

Herein, FIGS. 8A and 8B are explanatory diagrams respectively corresponding to FIGS. 6A, (13) and 6B, (14) showing the optical element removal process.

When carrying out this invention in the manner as described above, the existing equipment for tightly abutting and fixing the lower mold 20 on the platform 70 at the time of assembly/disassembly of the press mold can be used as it is as exhaust means for sucking the atmospheric gas.

As described above, according to this invention, the molding material is supplied to the molding surface of the lower mold such that the peripheral portion of the molding material on its lower side is supported by the support member and, therefore, it is possible to hold the molding material in the state where the molding material is securely disposed at the predetermined position without causing the slip-off or position offset even if the molding surface of the lower mold has the convex or flat surface. Further, the open space is ensured outward of the edge portion of the molding material supported by the support member so that the stable support of the molding material is enabled even if there is variation in size among the molding materials.

This makes it possible to prevent the thickness deviation in the press molding so that the surface accuracy of the optical element to be obtained becomes excellent.

This invention is applicable to a press mold that is adapted to press-mold a molding material such as a glass by the use of an upper mold and a lower mold applied with precision machining and does not require post-processing such as polishing with respect to a molded surface, and further applicable to an optical element manufacturing method using such a press mold.

What is claimed is:

1. A press mold comprising a lower mold formed with a molding surface having a convex or flat surface and an upper mold formed with a molding surface facing the molding surface of said lower mold, said press mold being adapted to press-mold between said upper and lower molds a molding material supplied to said lower mold,
wherein a support member is provided around the molding surface of said lower mold for supporting a peripheral portion of said molding material on its lower side and said support member supports said molding material so as to provide an open space outward of an edge portion of said molding material.

2. A press mold according to claim 1, further comprising a sleeve allowing said upper and lower molds to be inserted thereinto from its both end sides, respectively, wherein said sleeve regulates a horizontal relative position between said upper and lower molds.

3. A press mold according to claim 2, wherein said support member is detachably provided.

4. A press mold according to claim 2, wherein said support member is formed in an annular shape and is placed on a stepped portion formed around the molding surface of said lower mold at a position lower than the molding surface of said lower mold.

5. A press mold according to claim 3, wherein said support member is forme in an annular shape and is placed on a stepped portion formed around the molding surface of said lower mold at a position lower than the molding surface of said lower mold.

6. A press mold according to claim 4, wherein said support member has a vent hole at a position intermediate between the molding surface of said lower mold and said stepped portion in an axial direction of said support member.

7. A press mold according to claim 6, wherein said support member has a tapered inner periphery that reduces its inner diameter as going downward.

8. An optical element manufacturing method that uses a press mold comprising a lower mold formed with a molding surface having a convex or flat surface and an upper mold formed with a molding surface facing the molding surface of said lower mold and supplies a molding material to said lower mold, thereby press-molding said molding material, said optical element manufacturing method comprising:
supplying said molding material so that a peripheral portion of said molding material on its lower side is supported by a support member and further an open space is ensured outward of an edge portion of said molding material supported by said support member, and then causing said upper and lower molds to approach each other to thereby press-mold said molding material.

9. An optical element manufacturing method according to claim 8, wherein said molding material has a convex curved surface.

10. An optical element manufacturing method according to claim 8, wherein the peripheral portion of said molding material on its lower side is supported at a ridge portion of said support member.

11. An optical element manufacturing method according to claim 8, wherein a horizontal relative position between said upper and lower molds is regulated by a sleeve allowing said upper and lower molds to be inserted thereinto from its both end sides, respectively, thereby press-molding said molding material.

12. An optical element manufacturing method according to claim 11, wherein said molding material is supported by said support member in a non-contact state with the molding surface of said lower mold and then is press-molded.

13. An optical element manufacturing method according to claim 11, wherein said sleeve and said support member are provided with vent holes and an atmospheric gas existing between the molding material supported by said support member and the molding surface of said lower mold is discharged to the outside of said press mold through said vent holes when said upper and lower molds approach each other.

14. An optical element manufacturing method according to claim 12, wherein said sleeve and said support member are provided with vent holes and an atmospheric gas existing between the molding material supported by said support member and the molding surface of said lower mold is discharged to the outside of said press mold through said vent holes when said upper and lower molds approach each other.

15. An optical element manufacturing method according to claim 11, wherein said molding material has a diameter larger than an optical element effective diameter.

16. An optical element manufacturing method according to claim 12, wherein said molding material has a diameter larger than an optical element effective diameter.

17. An optical element manufacturing method according to claim 15, further comprising carrying out a centering process for removing an outer peripheral portion of an obtained molded article after press molding.

18. An optical element manufacturing method according to claim 16, further comprising carrying out a centering process for removing an outer peripheral portion of an obtained molded article after press molding.

19. An optical element manufacturing method according to claim 8, further comprising removing an obtained molded article from said press mold along with said support member after press molding, and then separating said molded article and said support member from each other.

20. An optical element manufacturing method according to claim 8, wherein said support member is used that has a tapered inner periphery which reduces its inner diameter as going downward.

21. An optical element manufacturing method according to claim 8, wherein said molding material is obtained by separating a molten glass while being dropped or poured onto a receiving mold so as to be preformed, or further applying shape processing to a glass block after having been separated while being dropped or poured onto the receiving mold, so as to be preformed.

22. An optical element manufacturing method according to claim 8, wherein the molding material placed inside said press mold is press-molded by transferring said press mold to a plurality of process chambers including a heating chamber, a press chamber, and a cooling chamber and applying thereto processes including heating, pressing, and cooling in the respective process chambers.
